(19) United States
(12) Patent Application Publication
(10) Pub. No.: US 2008/0242140 A1
(43) Pub. Date: Oct. 2, 2008

(54) MALE CONNECTOR AND MATCHED FEMALE CONNECTOR THEREOF

(75) Inventor: ZHENG-XIN GAO, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 11/944,426

(22) Filed: Nov. 22, 2007

(30) Foreign Application Priority Data
Apr. 2, 2007 (CN) 200710200378.6

(51) Int. Cl. H01R 13/627

(52) U.S. Cl. 439/357

(57) ABSTRACT

A male connector includes a main body, a plug extending from an end of the main body, and two elastic members attached to opposite sides of the main body. An end of each of the elastic members is secured to the main body near the end thereof, and the remaining portion of each of the elastic members is cantilevered towards an opposite end of the main body. Each of the elastic members includes a locking portion attached thereto configured for engaging with a female connector.

### BACKGROUND

1. Field of the Invention

The present invention relates to male connectors and their matched female connectors.

2. Description of Related Art

In a computer system, video graphics array interface (VGA) or digital visual interface (DVI) are used to couple a graphics card and a display. Two male connectors connected to ends of a data wire are respectively inserted in a female connector of the graphics card and a female connector of the display, such that data transmission between the graphics card and the display can be achieved.

To prevent the male connectors from disengaging from the corresponding female connectors after the graphics card and the display are connected by the data wire, male connectors are typically secured to the female connectors by screws. However, because of the space limitation for operating the screws with hands or tools such as screwdrivers, engaging or disengaging the connectors is inconvenient.

What is desired, therefore, are connectors which are convenient to be engaged and disengaged.

### SUMMARY

A male connector includes a main body, a plug extending from an end of the main body, and two elastic members attached to opposite sides of the main body. An end of each of the elastic members is secured to the main body near the end thereof, and the remaining portion of each of the elastic members is cantilevered towards an opposite end of the main body. Each of the elastic members includes a locking portion attached thereto configured for engaging with a female connector.

Other advantages and novel features will become more apparent from the following detailed description of embodiment when taken in conjunction with the accompanying drawings, in which:

### BRIEF DESCRIPTION OF THE DRAWINGS

FIG. 1 is an isometric view of two male connectors connected to a data wire in accordance with an embodiment of the present invention;

FIG. 2 is an exploded, isometric view of one of the male connectors and a graphics card;

FIG. 3 is an exploded, isometric view of the other one of the male connectors and a display;

FIG. 4 is an assembled view of FIG. 2; and

FIG. 5 is a front elevational, assembled view of FIG. 3;

### DETAILED DESCRIPTION

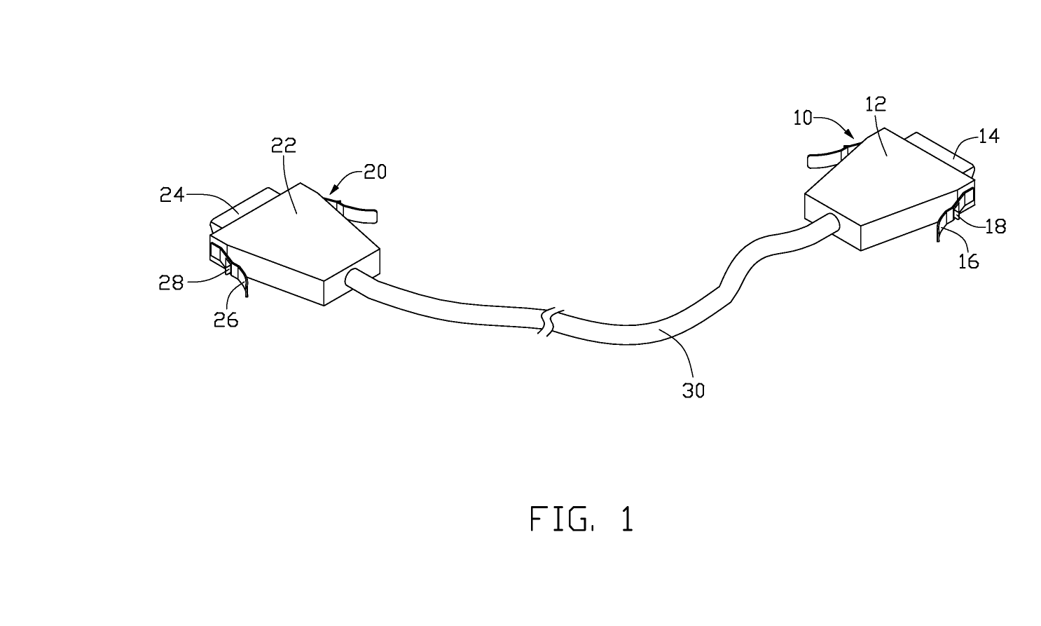

Referring to FIG. 1, two male connectors 10, 20 used for VGA or DVI are provided in accordance with an embodiment of the present invention. The two male connectors 10, 20 are respectively connected to two ends of a data wire 30. The male connectors 10, 20 include a main body 12, 22, a plug 14, 24, two elastic members 16, 26, and two locking portions 18, 28 respectively attached to the elastic members 16, 26.

The male connector 10 and the male connector 20 are same in structure, so only the male connector 10 will be described in detail hereinafter. The male connector 10 includes a trapezium-shaped main body 12. The data wire 30 is connected to a narrow end of the main body 12, and the plug 14 extends from a wide end of the main body 12. The elastic members 16 are thin metal pieces. One end of each elastic member 16 is attached to one side of the main body 12 near the plug, and the remaining portion of each elastic member 16 is cantilevered towards the narrow end of the main body 12, such that a sharp angle is formed between each elastic member 16 and the main body 12. Each locking portion 18 is wedge-shaped with a slanted guiding plane formed thereon. A sharp angle is formed between the guiding plane of the corresponding locking portion 18 and the elastic member 16.

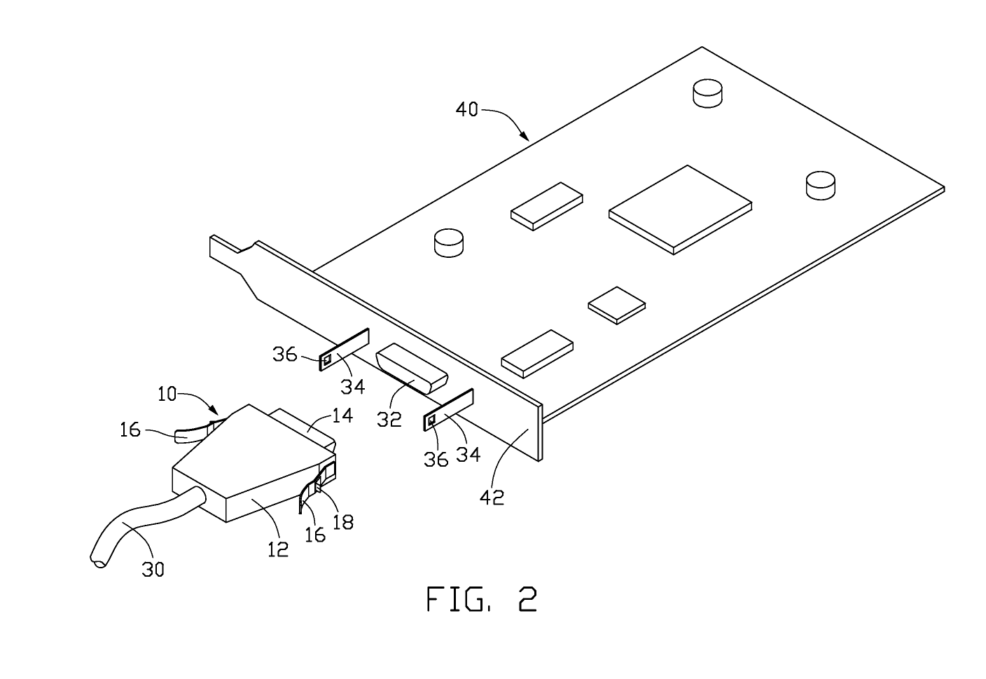

Referring to FIG. 2, a graphics card 40 includes a baffle 42 and a female connector used for VGA or DVI. The male connector 10 is used to couple with the female connector of the graphics card 40. The female connector of the graphics card 40 includes a receptacle 32 extending from the baffle 42 and two fixing members 34 extending from the baffle 42. The two fixing members 34 are parallel with each other and respectively placed at opposite sides of the receptacle 32. Each fixing member 34 is a rigid piece with a hole 36 defined therein.

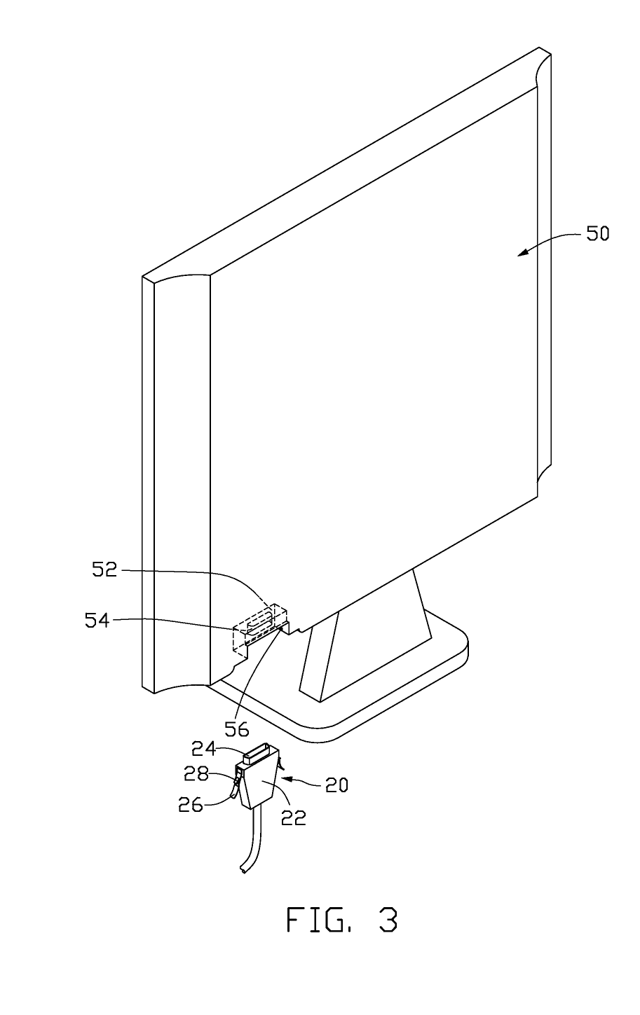

Referring to FIG. 3, a display 50 includes a receiving cavity 52 defined therein and a female connector of VGA/DVI set in the receiving cavity 52. The male connector 20 is used to couple with the female connector of the display 50. The female connector of the display 50 includes a receptacle 54 extending from a top wall of the receiving cavity 52 and two fixing members respectively formed on opposite sidewalls of the receiving cavity 52, and a groove 56 is defined in each fixing member.

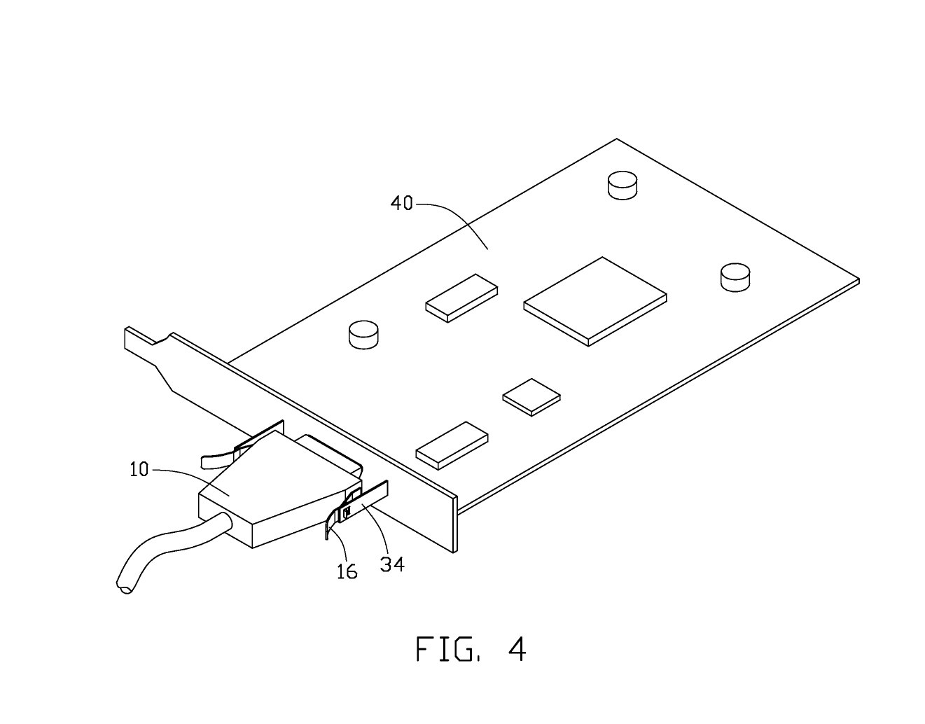

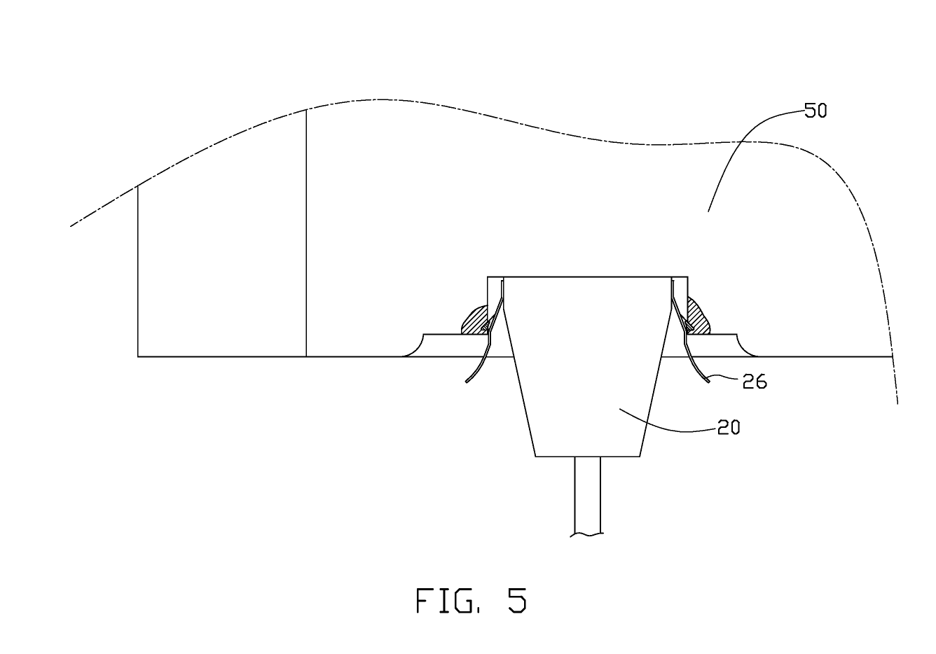

Referring also to FIGS. 4 and 5, in engaging the male connector 10 with the female connector of the graphics card 40, in one way to manipulate the male connector 10, a force is applied on each elastic member 16 of the male connector 10 to make them bend towards the main body 12, the plug 14 of the male connector 10 is moved towards the receptacle 32 of the female connector of the graphics card 40 until the plug 14 is completely inserted in the receptacle 32, the force applied to each elastic member 16 is released so that each elastic member 16 engages with the corresponding fixing member 34 under elastic restoring force, and the locking portion 18 of each elastic member 16 is received in the corresponding hole 36 of the fixing member 34, which prevents the male connector 10 from disengaging from the female connector of the graphics card 40; in another way to manipulate the male connector 10, the plug 14 of the male connector 10 is moved towards the receptacle 32 of the female connector of the graphics card 40 directly, each elastic member 16 is gradually bent by a pressure of the corresponding fixing member 34 in virtue of an engagement between the guiding plane of the locking portion 18 and the fixing member 34, the plug 14 is completely inserted in the receptacle 32 while the locking portion 18 is received in the corresponding hole 36 of the fixing member 34. In disengaging the male connector 10 from the female connector of the graphics card 40, a pressure is applied to each elastic member 16 of the male connector 10 to make it bend towards the main body 12, the locking portions 18 disengage from the corresponding holes 36 of the fixing members 34, then the male connector 10 can be easily pulled out. The way to engage the male connector 20 with the female connector of the display 50 or to disengage the male connector 20 from the female connector of the display 50 is the same as manipulating the male connector 10 as described above.

In other embodiments, a placement of the locking portions 18, 28 of the male connector may be interchanged with a placement of the corresponding holes 36 or grooves 56 of the male connector to achieve the same effect as above.

It is believed that the present embodiments and their advantages will be understood from the foregoing description, and they will be apparent that various changes may be made thereto without departing from the spirit and scope of the invention or sacrificing all of its material advantages, the examples hereinbefore described merely being preferred or exemplary embodiments of the invention.

What is claimed is:

1. A male connector comprising:
a main body;
a plug extending from an end of the main body; and
two elastic members attached to opposite sides of the main body, wherein an end of each of the elastic members is secured to the main body near said end thereof, the remaining portion of each of the elastic members is cantilevered towards an opposite end of the main body, each of the elastic members comprises at least one of a locking portion attached thereto and a hole defined therein configured for engaging with a female connector.

2. The male connector as claimed in claim 1, wherein the locking portion is wedge-shaped and extends from the elastic member.

3. The male connector as claimed in claim 1, wherein the male connector is a VGA or DVI connector.

4. A female connector comprising:
a receptacle; and
two fixing members set at opposite sides of the receptacle, each of the fixing members comprising at least one of a hole defined therein and a locking portion attached thereto configured for engaging with a male connector.

5. The female connector as claimed in claim 4, wherein the locking portion is wedge-shaped and extends from the fixing member.

6. The female connector as claimed in claim 4, wherein the fixing member is a rigid piece.

7. The male connector as claimed in claim 4, wherein the female connector is a VGA or DVI connector.
